(19) United States
(12) Patent Application Publication
(10) Pub. No.: US 2021/0070303 A1
(43) Pub. Date: Mar. 11, 2021

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Kaijiang Yu, Wako-shi (JP)

(21) Appl. No.: 17/012,084

(22) Filed: Sep. 4, 2020

(30) Foreign Application Priority Data
Sep. 9, 2019 (JP) 2019-163788

(51) Int. Cl. B60W 30/18; B60W 30/095; B60W 50/14

(52) U.S. Cl. CPC B60W 30/18163; B60W 50/14; B60W 30/0956

(57) ABSTRACT

A vehicle control device includes an action controller that is configured to control an action of the vehicle, in which the action controller is configured to determine a target vehicle traveling on a second roadway adjacent to a first roadway on which the vehicle is traveling from among one or more other vehicles, generate one or more virtual lane markings partitioning the second roadway on the basis of the target vehicle in a case where the vehicle is scheduled to move from the first roadway to the second roadway on the basis of a behavior of the target vehicle and a road lane marking partitioning the second roadway in a vicinity of the target vehicle cannot be recognized, and control the vehicle on the basis of the generated one or more virtual lane markings and the target vehicle.

### CROSS-REFERENCE TO RELATED APPLICATION

Priority is claimed on Japanese Patent Application No. 2019-163788, filed Sep. 9, 2019, the content of which is incorporated herein by reference.

### BACKGROUND

### Field

The present invention relates to a vehicle control device, a vehicle control method, and a storage medium.

### Description of Related Art

In the related art, there is a lane change control device that performs a lane change from a lane in which an own vehicle is located to a lane that is different from the lane while maintaining control of traveling of the own vehicle such that the own vehicle stays in the lane in a case where a winker flashing signal is input (for example, refer to PCT International Publication No. WO2017/047261). The lane change control device provides a virtual white line between a lane in which an own vehicle is traveling and a lane change destination and controls a lane change of crossing a real white line.

### SUMMARY

However, in the related art, a vehicle may not be able to smoothly travel in a target direction.

The present invention has been made in consideration of these circumstances, and one object thereof is to provide a vehicle control device, a vehicle control method, and a storage medium enabling a vehicle to travel in a target direction more smoothly.

The vehicle control device, the vehicle control method, and the storage medium related to the invention employ the following configurations.

(1): According to an aspect of the present invention, there is provided a vehicle control device including an acquirer that is configured to acquire a recognition result that is recognized by a recognizer recognizing a periphery of a vehicle; and an action controller that is configured to control an action of the vehicle, in which the action controller is configured to determine a target vehicle traveling on a second roadway adjacent to a first roadway on which the vehicle is traveling from among one or more other vehicles included in the recognition result acquired by the acquirer, generates one or more virtual lane markings partitioning the second roadway on the basis of the target vehicle in a case where the vehicle is scheduled to move from the first roadway to the second roadway on the basis of a behavior of the target vehicle and a road lane marking partitioning the second roadway in a vicinity of the target vehicle cannot be recognized, and controls the vehicle on the basis of the generated one or more virtual lane markings and the target vehicle.

(2): In the aspect of the above (1), the action controller is configured to generate the one or more virtual lane markings extending in a traveling direction of the target vehicle.

(3): In the aspect of the above (1) or (2), the action controller is configured to generate a first virtual lane marking that partitions the second roadway extending in a traveling direction of the target vehicle, and a second virtual lane marking that is present at a position farther than the first virtual lane marking from the vehicle and extends in parallel to the first virtual lane marking.

(4): In the aspect of the above (3), the action controller is configured to generate the second virtual lane marking in a case where the target vehicle moves to a third roadway adjacent to the second roadway.

(5): In the aspect of the above (3) or (4), the action controller is configured to generate the first virtual lane marking on a right of the second roadway with respect to an advancing direction of the vehicle in a case where a right roadway with respect to the advancing direction of the vehicle is set to the second roadway, and generate the first virtual lane marking on a left of the second roadway with respect to the advancing direction of the vehicle in a case where a left roadway with respect to the advancing direction of the vehicle is set to the second roadway.

(6): In the aspect of any one of the above (1) to (5), the action controller is configured to generate a third virtual lane marking that is located along a trajectory along which the vehicle is scheduled to move and is connected to a lane partitioned by a first virtual lane marking or a lane partitioned by a second virtual lane marking in a case where a road lane marking partitioning the second roadway in the vicinity of the target vehicle is not recognizable, the first virtual lane marking is a lane marking partitioning the second roadway extending in a traveling direction of the target vehicle, and the second virtual lane marking is a lane marking that is generated at a position farther than the first virtual lane marking from the vehicle and extends in parallel to the first virtual lane marking.

(7): In the aspect of the above (6), the action controller is configured to determine whether the third virtual lane marking will be connected to the lane partitioned by the first virtual lane marking or the lane partitioned by the second virtual lane marking on the basis of a trajectory along which the vehicle is scheduled to move.

(8): According to another aspect of the present invention, there is provided a vehicle control method of causing a computer to acquire a recognition result that is recognized by a recognizer recognizing a periphery of a vehicle; control an action of the vehicle; determine a target vehicle traveling on a second roadway adjacent to a first roadway on which the vehicle is traveling from among one or more other vehicles included in the acquired recognition result; generate one or more virtual lane markings partitioning the second roadway on the basis of the target vehicle in a case where the vehicle is scheduled to move from the first roadway to the second roadway on the basis of a behavior of the target vehicle and a road lane marking partitioning the second roadway in a vicinity of the target vehicle cannot be recognized; and control the vehicle on the basis of the generated one or more virtual lane markings and the target vehicle.

(9): According to still another aspect of the present invention, there is provided a non-transitory computer readable storage medium storing a program causing a computer to acquire a recognition result that is recognized by a recognizer recognizing a periphery of a vehicle; control an action of the vehicle; determine a target vehicle traveling on a second roadway adjacent to a first roadway on which the vehicle is traveling from among one or more other vehicles included in the acquired recognition result; generate one or more virtual lane markings partitioning the second roadway on the basis of the target vehicle in a case where the vehicle is scheduled to move from the first roadway to the second roadway on the basis of a behavior of the target vehicle and a road lane marking partitioning the second roadway in a vicinity of the target vehicle cannot be recognized; and control the vehicle on the basis of the generated one or more virtual lane markings and the target vehicle.

According to (1) to (9), a vehicle is enabled to travel in a target direction more smoothly.

### BRIEF DESCRIPTION OF THE DRAWINGS

FIG. 1 is a diagram showing a configuration of a vehicle system using a vehicle control device related to an embodiment.

FIG. 2 is a diagram showing functional configurations of a first controller and a second controller.

FIG. 3 is a diagram showing a situation of a scenario 1 showing specific control.

FIG. 4 is a diagram showing a situation of a scenario 2 showing the specific control.

FIG. 5 is a diagram showing a situation of a scenario 3 showing the specific control.

FIG. 6 is a diagram showing a situation of a scenario 4 showing the specific control.

FIG. 7 is a diagram showing a situation of a scenario 5 showing the specific control.

FIG. 8 is a flowchart (first) showing an example of a flow of a process executed by an automated driving control device.

FIG. 9 is a flowchart (second) showing an example of a flow of a process executed by the automated driving control device.

FIG. 10 is a diagram (first) showing specific control related to a second embodiment.

FIG. 11 is a diagram (second) showing the specific control related to the second embodiment.

FIG. 12 is a flowchart showing an example of a flow of a process executed by an automated driving control device 100 of the second embodiment.

FIG. 13 is a diagram showing an example of a functional configuration of a vehicle control system.

FIG. 14 is a diagram showing an example of a hardware configuration of the automated driving control device of the embodiment.

### DETAILED DESCRIPTION

Hereinafter, with reference to the drawings, a vehicle control device, a vehicle control method, and a storage medium according to embodiments of the present invention will be described. As used throughout this disclosure, the singular forms “a,” “an,” and “the” include plural reference unless the context clearly dictates otherwise.

### First Embodiment

Overall Configuration

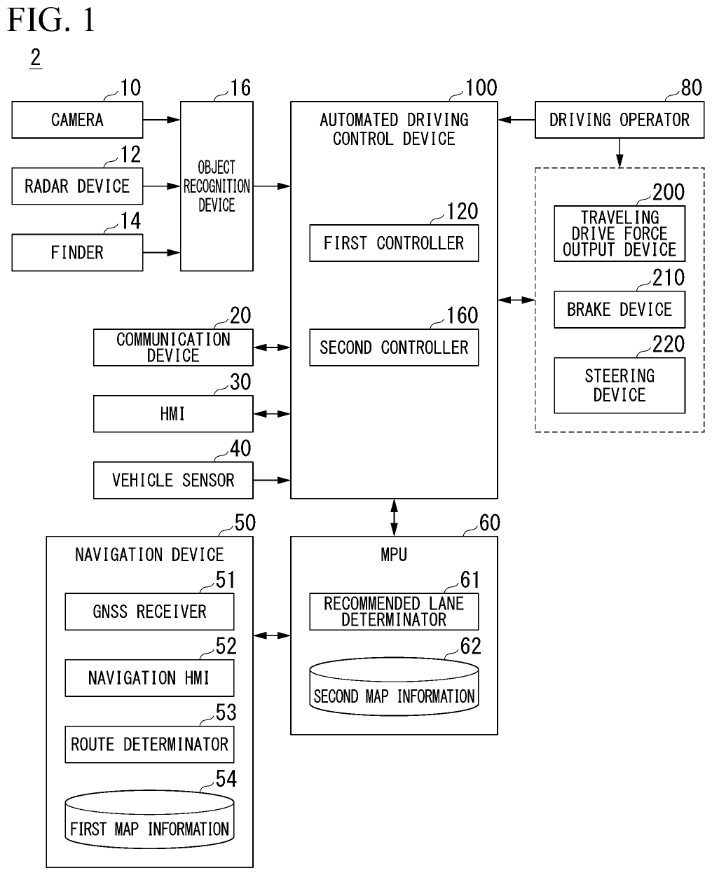

FIG. 1 is a diagram showing a configuration of a vehicle system 2 using a vehicle control device according to an embodiment. A vehicle having the vehicle system 2 mounted thereon is, for example, a two-wheeled, three-wheeled, or four-wheeled vehicle, and a drive source thereof is an internal combustion engine such as a diesel engine or a gasoline engine, a motor, or a combination thereof. The motor is operated by using power generated by a generator connected to the internal combustion engine or power released from a secondary battery or a fuel cell.

The vehicle system 2 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a traveling drive force output device 200, a brake device 210, and a steering device 220. The devices and the apparatuses are connected to each other via a multiplex communication line such as a controller area network (CAN) communication line, a serial communication line, or a wireless communication network. The configuration shown in FIG. 1 is only an example, and some of the constituents may be omitted, and other constituents may be added.

The camera 10 is a digital camera using a solid-state imaging element such as a charge coupled device (CCD) or a complementary metal oxide semiconductor (CMOS). The camera 10 is attached at any location in a vehicle (hereinafter, an own vehicle M) on which the vehicle system 2 is mounted. In a case where the front side is imaged, the camera 10 is attached to the upper part of a front windshield, the back surface of an interior mirror, or the like. For example, the camera 10 periodically and repeatedly images the periphery of the own vehicle M. The camera 10 may be a stereo camera.

The radar device 12 radiates electric waves such as millimeter waves in the periphery of the own vehicle M, detects electric waves (reflected waves) reflected by an object, and thus detects at least a position (a distance and an azimuth) of the object. The radar device 12 is attached at any location in the own vehicle M. The radar device 12 may detect a position and a speed of an object according to a frequency modulated continuous wave (FM-CW) method.

The finder 14 is light detection and ranging (LIDAR). The finder 14 applies light in the periphery of the own vehicle M, and measures scattered light. The finder 14 detects a distance to a target on the basis of a time from light emission to light reception. The applied light is, for example, pulsed laser light. The finder 14 is attached at any location in the own vehicle M.

The object recognition device 16 performs a sensor fusion process on detection results from some or all of the camera 10, the radar device 12, and the finder 14, and thus recognizes a position, the type, a speed, and the like of an object. The object recognition device 16 outputs a recognition result to the automated driving control device 100. The object recognition device 16 may output detection results from the camera 10, the radar device 12, and the finder 14 to the automated driving control device 100 without change. The object recognition device 16 may be omitted from the vehicle system 2.

The communication device 20 performs communication with another vehicle present in the periphery of the own vehicle M, or performs communication with various server apparatus via a wireless base station by using, for example, a cellular network, a Wi-Fi network, Bluetooth (registered trademark), or Dedicated Short Range Communication (DSRC).

The HMI 30 presents various pieces of information to an occupant of the own vehicle M, and also receives an input operation from the occupant. The HMI 30 includes various display devices, a speaker, a buzzer, a touch panel, switches, keys, and the like.

The vehicle sensor 40 includes, for example, a vehicle speed sensor detecting a speed of the own vehicle M, an acceleration sensor detecting acceleration, a yaw rate sensor detecting an angular speed about a vertical axis, and an azimuth sensor detecting an orientation of the own vehicle M.

The navigation device 50 includes, for example, a global navigation satellite system (GNSS) receiver 51, a navigation HMI 52, and a route determinator 53. The navigation device 50 stores first map information 54 in a storage device such as a hard disk drive (HDD) or a flash memory. The GNSS receiver 51 identifies a position of the own vehicle M on the basis of a signal received from a GNSS satellite. A position of the own vehicle M may be identified or complemented by an inertial navigation system (INS) using an output from the vehicle sensor 40. The navigation HMI 52 includes a display device, a speaker, a touch panel, keys, and the like. The navigation HMI 52 may be partially or entirely integrated into the HMI 30 described above. The route determinator 53 determines, for example, a route (hereinafter, a route on a map) from a position of the own vehicle M identified by the GNSS receiver 51 (or any entered position) to a destination that is entered by an occupant by using the navigation HMI 52 on the basis of the first map information 54. The first map information 54 is, for example, information in which a road shape is expressed by a link indicating a road and nodes connected to each other via the link. The first map information 54 may include a curvature of a road, point of interest (POI) information, and the like. The route on the map is output the MPU 60. The navigation device 50 may perform route guidance using the navigation HMI 52 on the basis of the route on the map. The navigation device 50 may be implemented, for example, by a function of a terminal apparatus such as a smartphone or a tablet terminal carried by the occupant. The navigation device 50 may transmit the current position and the destination to a navigation server via the communication device 20, and may acquire a route equivalent to the route on the map from the navigation server.

The MPU 60 includes, for example, a recommended lane determinator 61, and stores second map information 62 in a storage device such as an HDD or a flash memory. The recommended lane determinator 61 divides the route on the map provided from the navigation device 50 into a plurality of blocks (for example, divides the route on the map every 100 m in a vehicle advancing direction), and determines a recommended lane for each block by referring to the second map information 62. The recommended lane determinator 61 determines in which lane from the left the own vehicle will travel. In a case where there is a branch location on the route on the map, the recommended lane determinator 61 determines a recommended lane such that the own vehicle M can travel on a reasonable route to advance to a branch destination.

The second map information 62 is map information with higher accuracy than that of the first map information 54. The second map information 62 includes, for example, lane center information or lane boundary information. The second map information 62 may include road information, traffic regulation information, address information (address/postal code), facility information, telephone number information, and the like. The second map information 62 may be updated at any time by the communication device 20 performing communication with other devices. The map information may include road lanes, road lane markings partitioning the road lanes from each other, and the like.

The driving operator 80 includes, for example, an accelerator pedal, a brake pedal, a shift lever, a steering wheel, an odd-shaped steering wheel, a joystick, and other operators. The driving operator 80 is attached with a sensor detecting an operation amount or whether or not an operation is performed, and a detection result is output to the automated driving control device 100 or some or all of the traveling drive force output device 200, the brake device 210, and the steering device 220.

The automated driving control device 100 includes, for example, a first controller 120 and a second controller 160. Each of the first controller 120 and the second controller 160 is realized, for example, by a hardware processor such as a central processing unit (CPU) executing a program (software). Some or all of the constituents may be realized by hardware (a circuit portion; including a circuitry) such as a large scale integration (LSI), an application specific integrated circuit (ASIC), a field-programmable gate array (FPGA), or a graphics processing unit (GPU), and may be realized by software and hardware in cooperation. The program may be stored in advance in a storage device (a storage device provided with a non-transitory storage medium) such as an HDD or a flash memory of the automated driving control device 100, and may be stored in an attachable and detachable storage medium (non-transitory storage medium) such as a DVD or a CD-ROM and may be installed in the HDD or the flash memory of the automated driving control device 100 when the storage medium is attached to a drive device. The automated driving control device 100 is an example of a “vehicle control device”, and a combination of an action plan generator 140 and the second controller 160 is an example of an “action controller”.

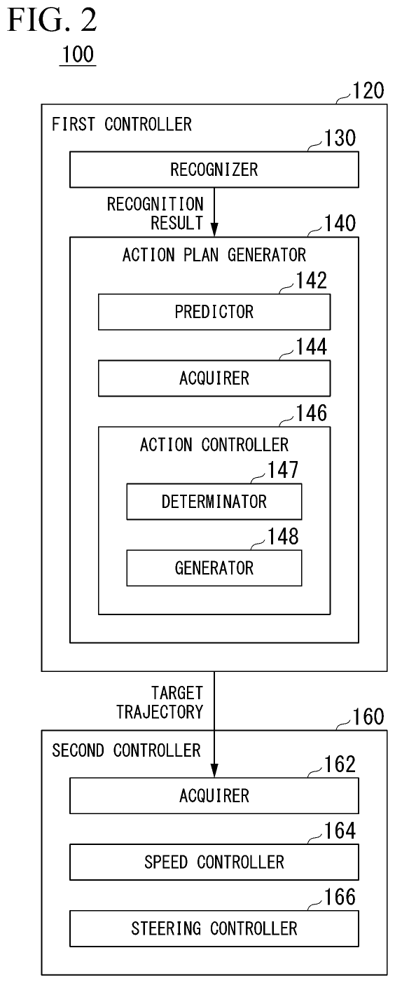

FIG. 2 is a diagram showing a functional configuration of the first controller 120 and the second controller 160. The first controller 120 includes, for example, a recognizer 130 and an action plan generator 140. The first controller 120 is realized by combining, for example, a function of artificial intelligence (AI) with a function of a model provided in advance. For example, a function of “recognizing an intersection” may be realized by executing recognition of the intersection using deep learning and recognition based on conditions (for example, there are a signal that can be matched with a pattern, and a road marking) given in advance in parallel, and scoring and comprehensively evaluating both of recognition results. Consequently, the reliability of automated driving is ensured.

The recognizer 130 recognizes states of an object, such as a position, a speed, and an acceleration in the vicinity of the own vehicle M on the basis of information that is input from the camera 10, the radar device 12, and the finder 14 via the object recognition device 16. The position of the object is recognized as, for example, a position in an absolute coordinate system having a representative point (for example, the centroid or the drive axis center) of the own vehicle M as an origin, and is used for control. The position of the object may be represented by a representative point such as the centroid or a corner of the object, and may be represented by an expressed region. The “states” of the object may include an acceleration, a jerk, or an “action state” of the object (for example, the object is trying to change lanes or whether or not the object is trying to change lanes).

The action plan generator 140 generates one or more target trajectories on which the own vehicle M automatedly (regardless of an operation of a driver) travels in the future such that the own vehicle can travel in a recommended lane determined by the recommended lane determinator 61 in principle and can cope with a peripheral situation of the own vehicle M. The target trajectory includes, for example, a speed element. For example, the target trajectory is expressed by sequentially arranging locations (trajectory points) to be reached by the own vehicle M. The trajectory points are locations to be reached by the own vehicle M every predetermined traveling distance (for example, about several [m]) in terms of a distance along a road, and, separately therefrom, a target speed and a target acceleration for each predetermined sampling time (for example, any of about 0.1 to 0.9 seconds) are generated as parts of the target trajectory. A trajectory point may be a position to be reached by the own vehicle M at a sampling time point every predetermined sampling time. In this case, information regarding the target speed or the target acceleration may be expressed by an interval between trajectory points.

The action plan generator 140 may set an automated driving event when generating the target trajectory. The automated driving event includes, for example, a constant speed traveling event, a low speed following traveling event, a lane change event, a branch event, a merging event, and a takeover event. The action plan generator 140 generates a target trajectory corresponding to a started event. For example, when the target trajectory is generated, the action plan generator 140 generates the target trajectory in consideration of a processing result from an action controller 146 which will be described later.

The action plan generator 140 includes, for example, a predictor 142, an acquirer 144, and the action controller 146. The predictor 142 predicts a future position of another vehicle present in the periphery of the own vehicle M on the basis of a recognition result from the recognizer 130. For example, the predictor 142 predicts a direction in which another vehicle will travel or a position where another vehicle will be present a predetermined time later on the basis of a behavior (a vehicle speed or an acceleration) or the past action history of another vehicle. The acquirer 144 acquires the current position of another vehicle recognized by the recognizer 130 and the future position of another vehicle predicted by the predictor 142.

The action controller 146 controls an action of the vehicle on the basis of the information acquired by the acquirer 144. The action controller 146 includes, for example, a determinator 147 and a generator 148. The determinator 147 determines a target vehicle from among one or more vehicles. The generator 148 generates a virtual lane marking. The action controller 146 controls the vehicle M on the basis of the virtual lane marking generated by the generator 148. For example, the action controller 146 controls the vehicle M such that the vehicle M travels on a target trajectory that is generated by the action plan generator 140 on the basis of the virtual lane marking and the behavior of the target vehicle. Details of processes in the action controller 146, the determinator 147, and the generator 148 will be described later.

The second controller 160 controls the traveling drive force output device 200, the brake device 210, and the steering device 220 such that the own vehicle M can pass along the target trajectory generated by the action plan generator 140 as scheduled.

Referring to FIG. 2 again, the second controller 160 includes, for example, an acquirer 162, a speed controller 164, and a steering controller 166. The acquirer 162 acquires information regarding the target trajectory (trajectory point) generated by the action plan generator 140, and stores the information in a memory (not shown). The speed controller 164 controls the traveling drive force output device 200 or the brake device 210 on the basis of a speed element included in the target trajectory stored in the memory. The steering controller 166 controls the steering device 220 according to a curved state of the target trajectory stored in the memory. Processes in the speed controller 164 and the steering controller 166 are realized by a combination of, for example, feedforward control and feedback control. As an example, the steering controller 166 executes a combination of feedforward control based on a curvature of a road in front of the own vehicle M and feedback control based on deviation from the target trajectory.

The traveling drive force output device 200 outputs traveling drive force (torque) for traveling of the vehicle to drive wheels. The traveling drive force output device 200 includes, for example, a combination of an internal combustion engine, a motor, and a transmission, and an electronic control unit (ECU) controlling the constituents. The ECU controls the constituents according to information that is input from the second controller 160 or information that is input from the driving operator 80.

The brake device 210 includes, for example, a brake caliper, a cylinder that transmits hydraulic pressure to the brake caliper, an electric motor that generates the hydraulic pressure in the cylinder, and a brake ECU. The brake ECU controls the electric motor on the basis of information being input from the second controller 160 or information being input from the driving operator 80, so that brake torque corresponding to a braking operation is output to each vehicle wheel. The brake device 210 may include a mechanism, as a backup, transmitting hydraulic pressure generated by operating the brake pedal included in the driving operator 80, to the cylinder via a master cylinder. The brake device 210 may be an electronic control type hydraulic brake device that controls an actuator according to information being input from the second controller 160 and thus transmits hydraulic pressure in a master cylinder to the cylinder.

The steering device 220 includes, for example, a steering ECU and an electric motor. The electric motor changes an orientation of a turning wheel by applying force to, for example, a rack-and-pinion mechanism. The steering ECU drives the electric motor on the basis of information being input from the second controller 160 or information being input from the driving operator 80, so that an orientation of the turning wheel is changed.

Outline of Specific Control

The action controller 146 determines a target vehicle traveling on a second roadway adjacent to a first roadway on which the vehicle M is traveling among one or more other vehicles included in a recognition result acquired by the acquirer 144, generates one or more virtual lane markings partitioning the second roadway on the basis of the target vehicle in a case where the vehicle M is scheduled to move from the first roadway to the second roadway on the basis of a behavior of the target vehicle and road lane markings partitioning the second roadway cannot be recognized, and controls the vehicle M on the basis of the generated one or more virtual lane markings. Hereinafter, this control will be referred to as “specific control” in some cases.

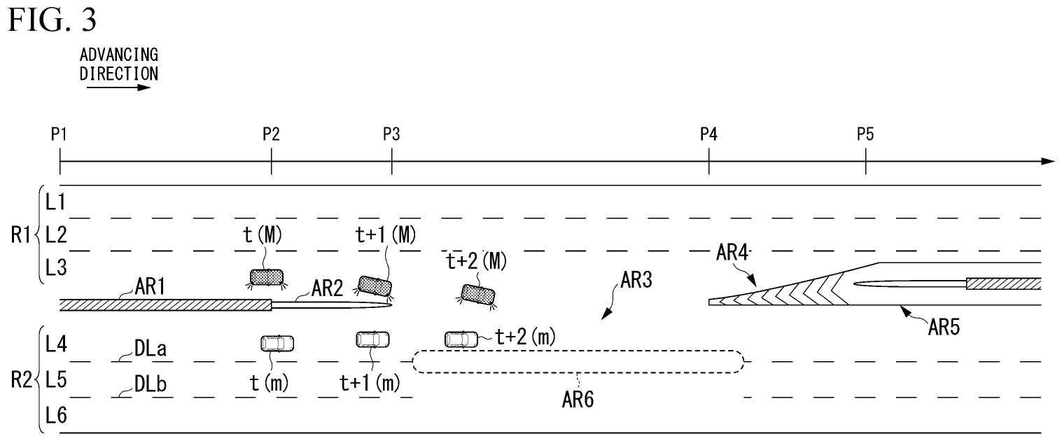

The first roadway is a road or a lane on or in which the vehicle M is traveling, and a second road R2 is a road or a lane (lane change destination) that the vehicle M is scheduled to enter. The first roadway is one road (or a lane included in the road) of a first road R1 (or a lane included in the first road R1) shown in FIG. 3 which will be described later and the second road R2 (or a lane included in the second road R2) which will be described later. The second roadway is the second road R2 (a lane included in the second road R2) in a case where the first roadway is the first road R1 (a lane included in the first road R1), and is the first road R1 (a lane included in the first road R1) in a case where the first roadway is the second road R2 (a lane included in the second road R2).

Specific Control (1)

Scenario 1

FIG. 3 is a diagram showing a situation of a scenario 1 showing specific control. Vehicles traveling on the first road R1 and the second road R2 are advancing in the same direction. The vehicles are traveling from a position P1 toward a position P5 in FIG. 3. FIG. 3 shows a road environment in which the first road R1 merges with the second road R2. A first region AR1, a second region AR2, a third region AR3, and a fourth region AR4 are present between the first road R1 and the second road R2.

The first region AR1 is a region between the position P1 and the position P2, and is a region for dividing the first road R1 from the second road R2. An object having a predetermined height or more is provided in the first region AR1. The vehicle

M traveling on the first road R1 cannot recognize a status of the second road R2 across the first region AR1. The second region AR2 is a region between the position P2 and the position P3, and is a region for dividing the first road R1 from the second road R2. The vehicle M traveling on the first road R1 can recognize a situation of the second road R2 across the second region AR2.

The third region AR3 is a region between the position P3 and the position P4. The third region AR3 is a region in which a vehicle traveling on the first road R1 can move to the second road R2 or a vehicle traveling on the second road R2 can move to the first road RE The fourth region AR4 is a region between the position P4 and the position P5, and is a flow guide region for guiding an advancing direction of a vehicle. A fifth region ARS is a region provided with the position P5 as a start point, and is a region for dividing the first road R1 from the second road R2.

The first road R1 includes, for example, a lane L1, a lane L2, and a lane L3. The second road R2 includes, for example, a lane L4, a lane L5, and a lane L6. For example, the vehicle M can enter the second road R2 from the first road R1 by changing a lane from the lane L3 to the lane L4 in the third region AR3.

For example, it is assumed that the vehicle M is scheduled to enter the second road R2 from the first road RE At time point t, the recognizer 130 recognizes another vehicle m traveling in the lane L4. Time point t is a time point at which the vehicle M reaches the position P2. Another vehicle m is a vehicle present in front of the vehicle M, for example, in the advancing direction.

The determinator 147 of the action controller 146 determines another vehicle m as a target vehicle. For example, the determinator 147 determines a vehicle closest to the vehicle M as a target vehicle among vehicles traveling in the lane L4 that the vehicle

M is scheduled to enter. The determinator 147 may determine a vehicle that is present in front of the vehicle M and is present at a position closest to the vehicle M in the advancing direction of the vehicle M as a target vehicle among vehicles traveling in the lane L4. The determinator 147 may determine a vehicle recognized at a time point after time point t as a target vehicle. The vehicle recognized at the time point after time point t is, for example, a vehicle traveling in the lane L4, and is a vehicle that is present at a position closest to the vehicle M and is present behind the vehicle M in the advancing direction of the vehicle M.

When the target vehicle is determined, the action controller 146 controls the vehicle M on the basis of the target vehicle. For example, the action controller 146 controls the vehicle M to be located in front of or behind the target vehicle in the lane L4. For example, the action controller 146 determines whether or not the vehicle M is to be located in front of the target vehicle on the basis of changes in the future positions of another vehicle m predicted by the predictor 142, changes in the future positions of the vehicle M in a case where the vehicle M is accelerated at an upper limit acceleration, and a position of an end point of the third region AR3. For example, in a case where the vehicle M is able to be located a predetermined distance in front of another vehicle m at a predetermined distance before the end point of the third region AR3, the action controller 146 determines that the vehicle M is to be located in front of the target vehicle.

At time point t+1, it is assumed that the recognizer 130 cannot recognize a road lane marking DLa partitioning the lane L4 in the vicinity of the target vehicle. The vicinity of the target vehicle indicates, for example, a range (for example, a range from the position P3 to the position P4) over a predetermined distance in front of the target vehicle in the advancing direction of the target vehicle. The phrase “cannot recognize the road lane marking DLa partitioning the lane L4 in the vicinity of the target vehicle” indicates, for example, that a part or the whole of the road lane marking DLa in a range AR6 over the predetermined distance in front of the target vehicle in the advancing direction is not recognized. In the example shown in FIG. 3, it is assumed that the whole of the road lane marking DLa in the range AR6 over the predetermined distance in front of the target vehicle in the advancing direction is not recognized. In examples shown in FIG. 3 and the subsequent drawings, it is also assumed that the recognizer 130 cannot recognize a road lane marking DLb partitioning the lane L5 from the lane L6 between the position P3 and the position P4. For example, the road lane marking may not be recognized due to the surrounding environment of a road such as a puddle or light, or deterioration in the road lane marking or other conditions.

Scenario 2

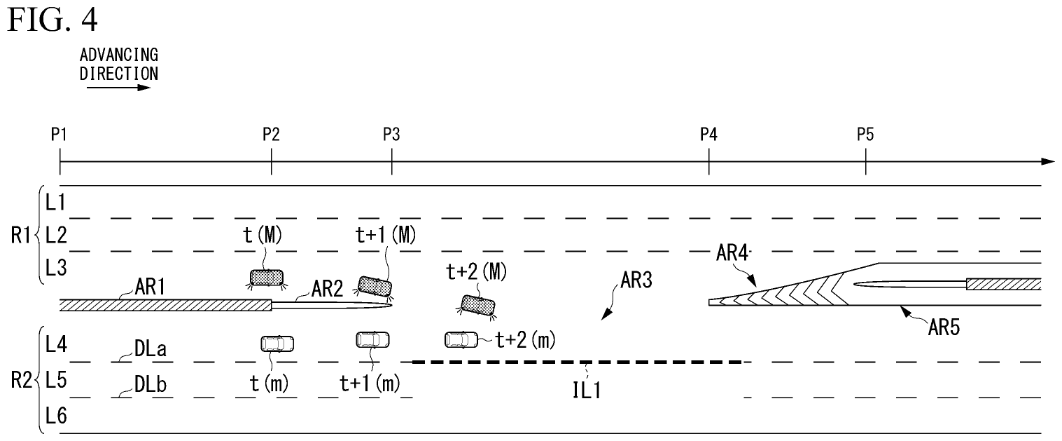

FIG. 4 is a diagram showing a situation of a scenario 2 showing the specific control. The same description as in FIG. 3 will not be repeated. At time point t+2, the generator 148 of the action controller 146 generates a first virtual lane marking IL1. The first virtual lane marking IL1 is a lane marking partitioning the lane L4 (an example of the “second roadway”) extending in the traveling direction of the target vehicle. A timing at which the first virtual lane marking IL1 is generated may be a timing such as time point t+1, and may be a timing between time point t+1 and time point t+2.

For example, the generator 148 generates the first virtual lane marking IL1 on the basis of one or both of the past traveling history of another vehicle m and a recognizable lane marking. The term “generate” may include setting a virtual road lane marking at a desired position on the second road R2. For example, the generator 148 may generate, as the first virtual lane marking IL1, a line (a line deviated to an intermediate location between the lane L4 and the lane L5) obtained by deviating a line connecting vehicle reference positions (for example, the center in a width direction) at the respective past time points to each other by a predetermined distance in a rightward direction with respect to the advancing direction of another vehicle m, and may generate, as the first virtual lane marking IL1, a line connecting positions of recognizable lane markings to each other. The generator 148 may generate the first virtual lane marking IL1 by integrating the virtual lines generated according to the methods with each other. The term “integrate” includes, for example, correcting a virtual line generated according to one method on the basis of a virtual line generated according to another method, and selecting a virtual line generated according to a method with high priority from among virtual lines generated according to different methods.

Scenario 3

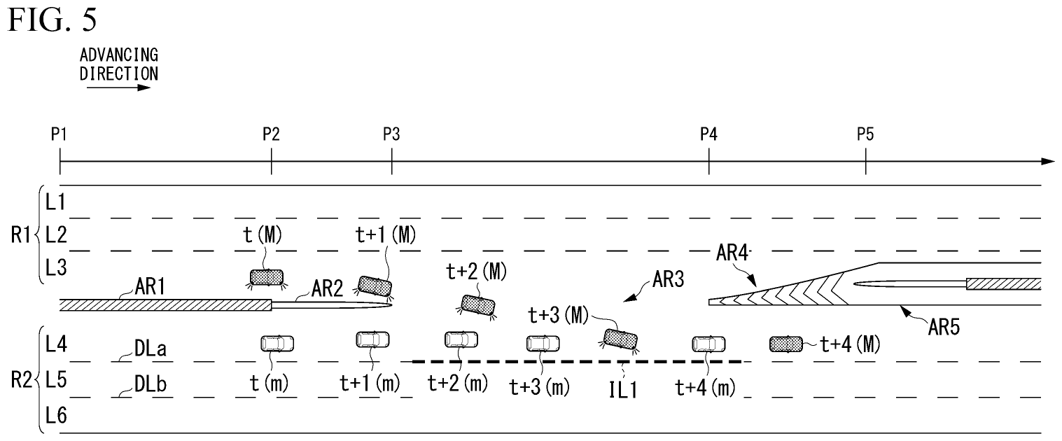

FIG. 5 is a diagram showing a situation of a scenario 3 showing the specific control. The same description as in FIG. 4 will not be repeated. The action controller 146 controls the vehicle M on the basis of the target vehicle and the first virtual lane marking IL1. At time point t+3, for example, the action controller 146 controls the vehicle M to overtake the target vehicle such that a reference position (for example, the center in the width direction) of the vehicle M is located at a position (the center of the lane L4 in the width direction) by a predetermined distance from a horizontal direction in the first virtual lane marking IL1. At time point t+4, the vehicle M is traveling in front of the target vehicle in the lane L4.

Here, for example, in a case where the first virtual lane marking IL1 is not generated, the vehicle M can easily determine a position of the vehicle M to be located on the second road R2 in the advancing direction on the basis of the target vehicle. However, in a case where a road lane marking cannot be recognized, the vehicle M may not be able to determine a position of the vehicle M to be located on the second road R2 in the horizontal direction or may not easily determine the position. Therefore, the vehicle M may not be able to smoothly enter the second road R2, and may not be able to enter in front of the target vehicle even though the vehicle M is scheduled to enter in front of the target vehicle. Even if the vehicle M has entered the second road R2, the reference position of the vehicle M may be located at a position deviated from the center of the lane L4 that is a lane change destination in the width direction or at a position exceeding the lane, and thus a position of the vehicle M may not be able to be appropriately controlled.

In contrast, in a case where a road lane marking partitioning a lane of the second road R2 is not recognized when the vehicle M is entering the second road R2, the action controller 146 of the present embodiment generates a virtual road lane marking. Consequently, the action controller 146 can control a position of the vehicle M on the basis of the generated virtual road lane marking. As a result, the vehicle M can smoothly enter the second road R2 from the first road RE The vehicle M can travel at an appropriate position on the road.

The specific control is useful in a case where the vehicle M is desired to travel in front of a target vehicle as in the above-described example. For example, in a case where the vehicle M desires to travel behind a target vehicle, the vehicle M may travel to follow the target vehicle. However, in a case where the vehicle M desires to travel in front of the target vehicle, it is not easy to determine a position through which the vehicle M travels when a road lane marking cannot be recognized. In the present embodiment, even when a road lane marking cannot be recognized in a case where the vehicle M desires to travel in front of a target vehicle, the vehicle M can easily and smoothly enter the second road R2 and travel in front of the target vehicle.

Specific Control (2)

Hereinafter, specific control (2) will be described. The specific control (2) is a process in a case where a target vehicle changes a lane from the lane L4 to the lane L5 when the vehicle M is entering the second road R2. In the specific control (2), in a case where the target vehicle changes a lane from the lane L4 to the lane L5, a virtual lane marking partitioning a lane that is a lane change destination of the target vehicle is generated. Hereinafter, a process that is different from the specific control (1) will be described.

Scenario (4)

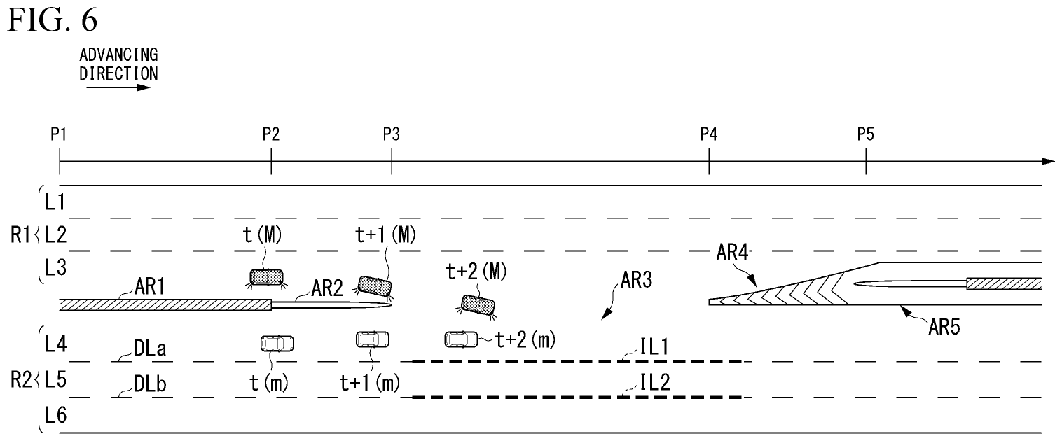

FIG. 6 is a diagram showing a situation of a scenario 4 showing the specific control. The same description as in FIG. 4 will not be repeated. The generator 148 generates a second virtual lane marking IL2 in a case where a target vehicle moves to the lane L5 (an example of a “third roadway”) adjacent to the lane L4. The term “move” indicates a case where a target vehicle has actually moved or is trying to move. The phrase “trying to move” indicates, for example, showing an intention to move. The phrase “showing an intention to move” satisfies two conditions, for example, that a target vehicle flashes a direction indicator in order to change a lane to the lane L5, and the target vehicle is traveling in a state of coming close to the lane L5 side for a predetermined time or more.

At time point t+2, for example, in a case where the target vehicle shows an intention to change a lane to the lane L5, the generator 148 generates the second virtual lane marking IL2 partitioning the lane L5 from the lane L6. The second virtual lane marking IL2 is a lane marking that is present at a position farther than the first virtual lane marking IL1 from a vehicle and extends in parallel to the first virtual lane marking IL1. The second virtual lane marking IL2 is generated, for example, between the lane L5 and the lane L6. In other words, the second virtual lane marking IL2 is a lane marking partitioning the lane L5 that is a lane change destination of the target vehicle from the adjacent lane L6 after lane change.

For example, the generator 148 generates the second virtual lane marking IL2 on the basis of one or both of the first virtual lane marking IL1 and a recognizable lane marking (a road lane marking partitioning the lane L4 from the lane L5). For example, the generator 148 may generate a line (a line obtained by deviating the first virtual lane marking IL1 in the direction of the lane L5 by a predetermined distance) between the lane L5 and the lane L6 as the second virtual lane marking IL2, and may generate the second virtual lane marking IL2 by integrating a plurality of methods with each other in the same manner as generation of the first virtual lane marking IL1. The second virtual lane marking IL2 may be generated when the first virtual lane marking IL1 is generated, and may be generated at any timing.

Scenario 5

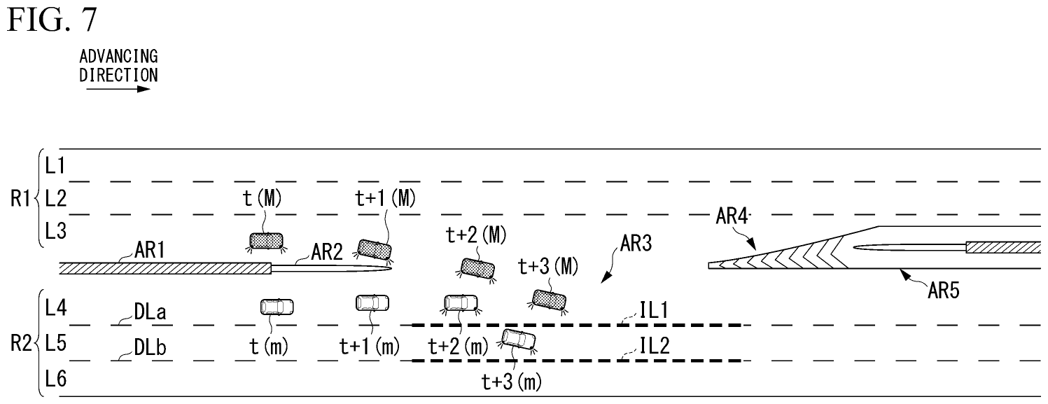

FIG. 7 is a diagram showing a situation of a scenario 5 showing the specific control. The same description as in FIG. 6 will not be repeated. At time point t+3, in a case where the target vehicle changes a lane to the lane L5, the action controller 146 causes the vehicle M to change a lane to the lane L4, for example, even though the vehicle M does not overtake the target vehicle or is not located a predetermined distance in front of the target vehicle in the advancing direction of the vehicle M. The action controller 146 causes the vehicle M to travel in the lane L4.

For example, in a case where the second virtual lane marking IL2 is not generated, it is not easy to predict to which position the target vehicle will move in the future. This is because the vehicle cannot recognize the road lane marking partitioning the lane L5 from the lane L6, and thus cannot predict that the target vehicle will travel through a position at a first distance, a second distance, or an N-th (where “N” is any natural number) distance from the first virtual lane marking ILE As mentioned above, in a case where the vehicle cannot predict the future position of the target vehicle, the action controller may not easily generate the future action plan for the vehicle, and may observe an action of the target vehicle in order to generate an action plan. In this case, for example, even if the target vehicle shows an intention to move to the lane L5 so as to give way to the vehicle, the next action of the vehicle (action regarding lane change) may be delayed, and thus the vehicle may not be able to smoothly enter the second road R2.

In contrast, the automated driving control device 100 of the present embodiment generates the second virtual lane marking IL2, and can thus easily predict the future position of the target vehicle. For example, the automated driving control device 100 can predict that the target vehicle will move to the lane L5 (a region between the first virtual lane marking IL1 and the second virtual lane marking IL2) or will travel in the lane L6 (a location on the right of the second virtual lane marking IL2) after moving to the lane L5, and generate an action plan for the vehicle M on the basis of the prediction result. As a result, the vehicle M can smoothly enter the second road R2.

Flowchart

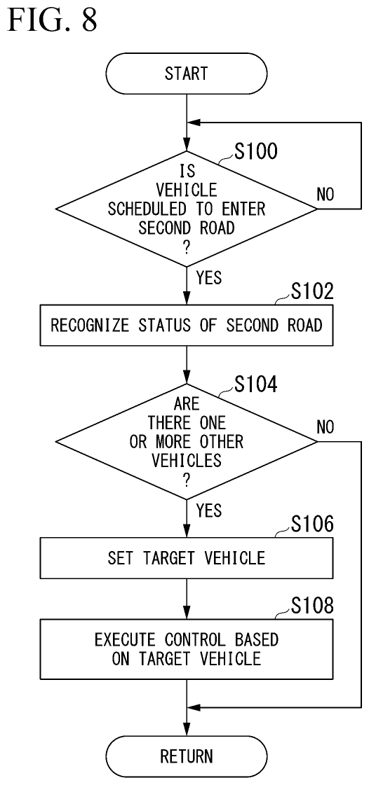

FIG. 8 is a flowchart (first) showing an example of a flow of a process executed by the automated driving control device 100. The process is started in a case where the vehicle M has reached a location a predetermined distance before the third region AR3.

First, the action controller 146 determines whether or not the vehicle M is scheduled to enter the second road R2 from the first road R1 (step S100). In a case where the vehicle M is scheduled to enter the second road R2, the recognizer 130 recognizes a status of the second road R2 (step S102). In a case where a status of the second road R2 cannot be recognized due to an object (a structure or the like) provided between the first road R1 and the second road R2, the flow proceeds to a process in step S104 in a case where the recognizer 130 can recognize a status of the second road R2. The determinator 147 determines whether or not one or more other vehicles m are present on the first road R1 on the basis of a recognition result in step S102 (step S104).

In a case where one or more other vehicles m are not present, the process in the flowchart is finished. In a case where one or more other vehicles m are present, the determinator 147 sets a target vehicle from among the one or more other vehicles m (step S106). Next, the action controller 146 executes control based on the set target vehicle (step S108). For example, the action controller 146 determines whether or not the vehicle M will enter in front of or behind the target vehicle, and executes control based on the determination result. For example, in a case where the vehicle will enter in front of the target vehicle, the vehicle M overtakes the target vehicle. Consequently, the process corresponding to one routine in the flowchart is finished.

Through the above-described process, the automated driving control device 100 can realize control for the vehicle M according to a traffic status in a case where the vehicle M enters the second road R2.

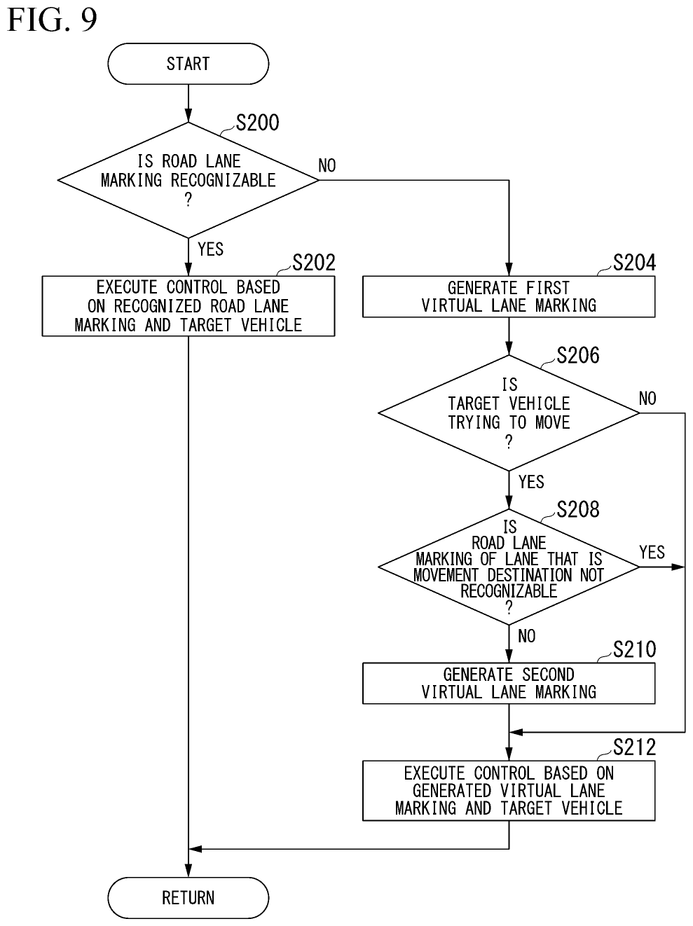

FIG. 9 is a flowchart (second) showing an example of a flow of a process executed by the automated driving control device 100. The process in the flowchart may be performed after the process in step S106 right after the process in the flowchart of FIG. 8 is started, and may be performed at any timing.

First, the recognizer 130 determines whether or not a road lane marking (for example, the road lane marking DLa) is recognizable (step S200). In a case where a road lane marking is recognizable, the action controller 146 executes control based on the recognized road lane marking and the target vehicle (step S202). For example, the vehicle M enters the lane L4 so as to cut in front of the target vehicle.

In a case where a road lane marking is not recognizable, the generator 148 generates the first virtual lane marking IL1 (step S204). Here, the phrase “a road lane marking is not recognizable” may merely indicate, for example, that the recognizer 130 cannot recognize a road lane marking in the vicinity of the third region AR3, and may indicate that information indicating that a road lane marking is displayed on a road is stored in map information but the recognizer 130 cannot recognize the road lane marking.

Next, the recognizer 130 determines whether or not the target vehicle is trying to move away from the vehicle M (step S206). In a case where the target vehicle is not trying to move away from the vehicle M (the target vehicle is not trying to change a lane to the lane L5), the flow proceeds to a process in step S212.

In a case where the target vehicle is trying to move away from the vehicle M, the recognizer 130 determines whether or not a road lane marking (for example, the road lane marking DLb) of the lane L5 that is a movement destination of the target vehicle is recognizable (step S208). In a case where a road lane marking of the lane L5 that is a movement destination of the target vehicle is recognizable, the flow proceeds to a process in step S212.

In a case where a road lane marking of the lane L5 that is a movement destination of the target vehicle is not recognizable, the generator 148 generates the second virtual lane marking IL2 (step S210). Next, the action controller 146 executes control based on a virtual lane marking (the first virtual lane marking IL1 or/and the second virtual lane marking IL2) and the target vehicle (step S212). Consequently, the process in the flowchart is finished.

Through the above-described process, the automated driving control device 100 can cause the vehicle M to smoothly enter a target position on the basis of a virtual lane marking and a behavior of a target vehicle.

In the above-described process, a description has been made of an example in which, in a case where a right roadway (second road R2) with respect to the advancing direction of the vehicle M is set to the second roadway, the generator 148 generates the first virtual lane marking IL1 on the right of the second roadway (lane L4) with respect to the advancing direction of the vehicle M. In a case where a left roadway with respect to the advancing direction of the vehicle M is set to the second roadway, the generator 148 may generate the first virtual lane marking on the left of the second roadway (lane L3) with respect to the advancing direction of the vehicle M. For example, in a case where the vehicle M enters the first road R1 (lane L3) from the second road R2 (lane L4), the first virtual lane marking IL1 may be generated on the first road R1 (for example, between the lane L2 and the lane L3).

According to the above-described first embodiment, in a case where a road lane marking partitioning the second road R2 in the vicinity of a target vehicle cannot be recognized, the automated driving control device 100 controls the vehicle M on the basis of one or more virtual lane markings partitioning the second road R2, generated on the basis of the target vehicle, and the target vehicle, and can thus cause the vehicle M to more smoothly enter the second road R2.

### Second Embodiment

Hereinafter, a second embodiment will be described. In the second embodiment, the generator 148 generates a third virtual lane marking. The third virtual lane marking is generated to be connected to a lane partitioned by the first virtual lane marking IL1 or the second virtual lane marking IL2. Hereinafter, the second embodiment will be described focusing on differences from the first embodiment.

The generator 148 of the second embodiment generates the third virtual lane marking that is located along a trajectory (hereinafter, a movement scheduled trajectory) along which the vehicle M is scheduled to move and is connected to the lane L4 partitioned by the first virtual lane marking IL1 or the lane L5 partitioned by the second virtual lane marking IL2 in a case where the road lane marking DLa partitioning the lane L4 in the vicinity of a target vehicle cannot be recognized. The generator 148 determines whether the third virtual lane marking will be connected to a lane (for example, the lane L4) partitioned by the first virtual lane marking IL1 or a lane (for example, the lane L5) partitioned by the second virtual lane marking IL2 on the basis of the movement scheduled trajectory of the vehicle M, and connects the third virtual lane marking to a virtual lane marking (the first virtual lane marking IL1 or the second virtual lane marking IL2) on the basis of a determination result.

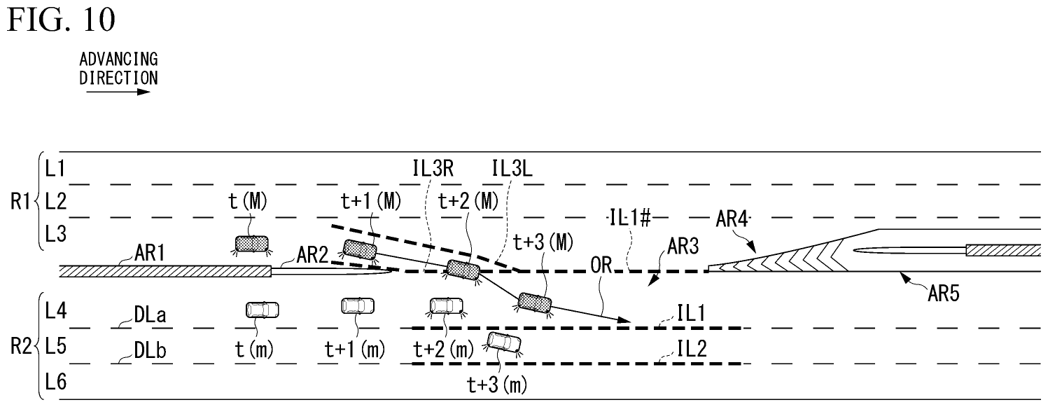

FIG. 10 is a diagram (first) showing specific control related to the second embodiment. The same description as in FIG. 7 will not be repeated. At time point t+1, for example, the action controller 146 is assumed to generate a movement scheduled trajectory OR. The movement scheduled trajectory OR is a trajectory used for the vehicle M to enter the lane L4. In this case, the generator 148 generates a third virtual lane marking IL3R and IL3L that are located along the movement scheduled trajectory OR and are connected to the lane L4 partitioned by the generated first virtual lane marking IL1. In the example shown in FIG. 10, the generator 148 generates the right third virtual lane marking IL3R and the left third virtual lane marking IL3L with respect to the advancing direction of the vehicle M, but may generate only one of the right third virtual lane marking IL3R and the left third virtual lane marking IL3L.

The action controller 146 controls the vehicle M to travel in a virtual lane (a region between the third virtual lane marking IL3R and the third virtual lane marking IL3L) defined by the third virtual lane marking IL3, and causes the vehicle M to move from the lane L3 to the lane L4 at a location where the virtual lane is connected to the lane L4. As shown in FIG. 10, the generator 148 may generate a first virtual lane marking IL1# in a case where a road lane marking is not recognized on the left with respect to the advancing direction of the target vehicle. The first virtual lane marking IL1# is a virtual lane marking extending in parallel to the first virtual lane marking IL1. In this case, a lane between the first virtual lane marking IL1 and the first virtual lane marking IL1# is an example of a lane partitioned by the first virtual lane marking.

Through the above-described process, the vehicle M can travel in the virtual lane and smoothly enter the lane L4 of the second road R2.

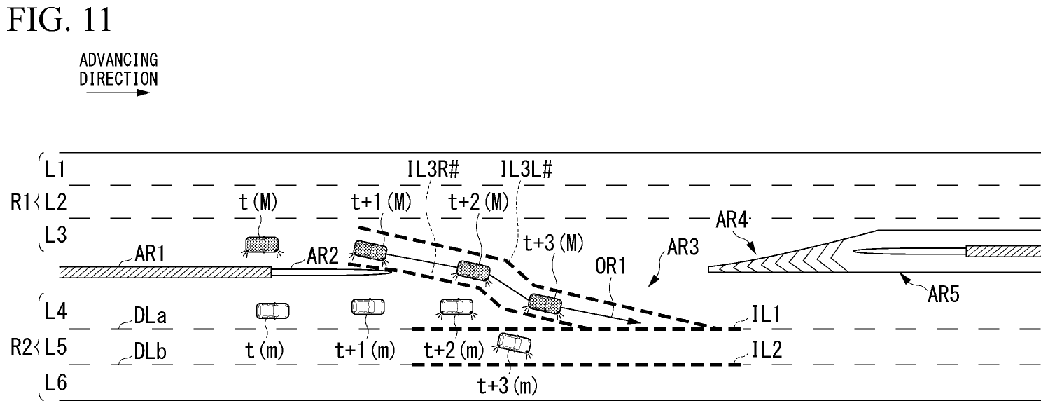

FIG. 11 is a diagram (second) showing the specific control related to the second embodiment. The same description as in FIGS. 7 and 10 will not be repeated. At time point t+1, for example, the action controller 146 is assumed to generate a movement scheduled trajectory OR1. The movement scheduled trajectory OR1 is a trajectory used for the vehicle M to enter the lane L5. In this case, the generator 148 generates third virtual lane markings IL3R# and IL3L# that are located along the movement scheduled trajectory OR1 and are connected to the lane L5 partitioned by the generated second virtual lane marking IL2.

The action controller 146 controls the vehicle M to travel in a virtual lane (a region between the third virtual lane marking IL3R# and the third virtual lane marking IL3L#) defined by the third virtual lane marking IL3, and causes the vehicle M to move from the lane L3 to the lane L4 at a location where the third virtual lane marking IL3 is connected to the lane L4. Further, the action controller 146 controls the vehicle M to travel in the virtual lane, and causes the vehicle M to move from the lane L4 to the lane L5 at a location where the third virtual lane marking IL3 (virtual lane) is connected to the lane L5. A lane (lane L5) between the first virtual lane marking IL1 and the second virtual lane marking IL2 is an example of a lane partitioned by the second virtual lane marking.

Through the above-described process, the vehicle M can travel in the virtual lane and smoothly enter the lane L5 of the second road R2.

Flowchart

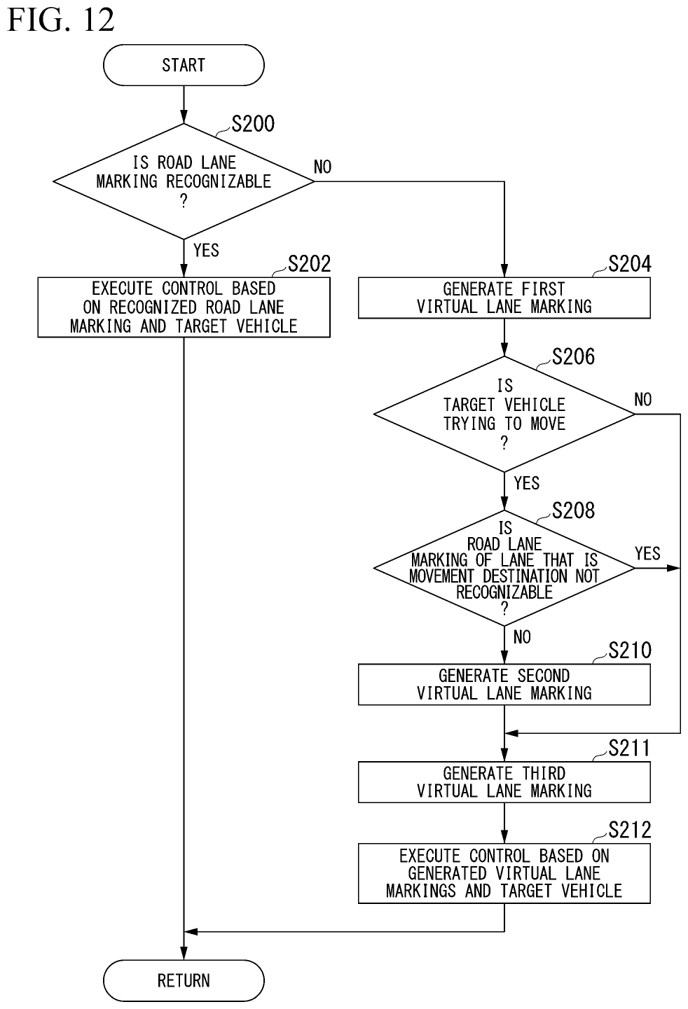

FIG. 12 is a flowchart showing an example of a flow of a process executed by the automated driving control device 100 of the second embodiment. The same process as in FIG. 9 will not be repeated, and a description will focus on differences from the process in FIG. 9. After the process in step S210, the generator 148 generates the third virtual lane marking IL3 (step S211). Next, the action controller 146 executes control based on the generated third virtual lane marking IL3 (step S212). Consequently, the process in the flowchart is finished.

According to the above-described second embodiment, the automated driving control device 100 generates the third virtual lane marking IL3 that is located along a movement scheduled trajectory of the vehicle M and is connected to a lane partitioned by the first virtual lane marking IL1 or a lane partitioned by the second virtual lane marking IL2, executes control based on the generated third virtual lane marking, and can thus cause the vehicle M to smoothly enter the second road R2. Modification Example

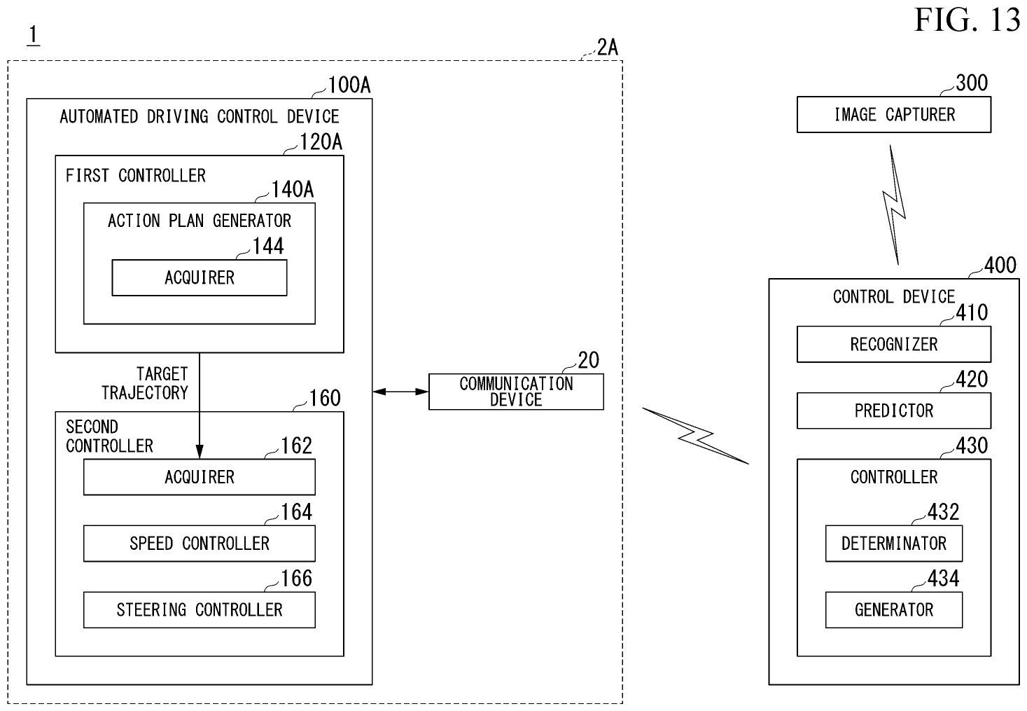

Some or all of the functional constituents included in the automated driving control device 100 may be provided in other devices. The vehicle M may be remotely operated by using, for example, a functional configuration shown in FIG. 13. FIG. 13 is a diagram showing an example of a functional configuration of a vehicle control system 1. The vehicle control system 1 includes, for example, a vehicle system 2A, an image capturer 300, and a control device 400. The vehicle system 2A performs communication with the control device 400, and the image capturer 300 performs communication with the control device 400. The vehicle system 2A and the control device 400 perform communication with each other so as to transmit or receive information required for the vehicle M to automatedly travel on the first road R1 or the second road R2.

The image capturer 300 is a camera that images the vicinity of a merging location where the first road R1 and the second road R2 shown in FIG. 3 and the like merge with each other. The image capturer 300 images the vicinity of the merging location, for example, from a bird's-eye view direction. In the example shown in FIG. 13, the single image capturer 300 is shown, but the vehicle control system 1 may include a plurality of image capturers 300.

The vehicle system 2A includes an automated driving control device 100A instead of the automated driving control device 100. In FIG. 13, functional constituents other than the automated driving control device 100A and the communication device 20 are not shown. The automated driving control device 100A includes a first controller 120A and a second controller 160. The first controller 120A includes an action plan generator 140A. The action plan generator 140A includes, for example, an acquirer 144.

The control device 400 includes, for example, a recognizer 410, a predictor 420, and a controller 430. The recognizer 410 recognizes a vehicle or a lane in the vicinity of the first road R1 and the second road R2, an object required for the vehicle M to travel, display, indication, and the like according to pattern matching, deep learning, and other image processing methods on the basis of an image captured by the image capturer 300. For example, the recognizer 410 has a function equivalent to that of the recognizer 130. The predictor 420 has a function equivalent to that of the predictor 142.

The controller 430 includes a determinator 432 and a generator 434. The determinator 432 and the generator 434 respectively have functions equivalent to those of the determinator 147 and the generator 148 of the first embodiment. The controller 430 generates a target trajectory along which the own vehicle M will automatedly travel in the future such that the own vehicle can travel in a recommended lane (a recommended lane corresponding to information transmitted to the vehicle M) determined by the recommended lane determinator 61 in principle and can cope with a peripheral situation of the own vehicle M. As described in the above-described respective embodiments, when a target trajectory is generated, the controller 430 performs specific control, and generates the target trajectory on the basis of a control result. The automated driving control device 100A causes the vehicle M to travel on the basis of the target trajectory transmitted from the control device 400.

According to the above-described embodiment, the automated driving control device 100 determines a target vehicle traveling on the second roadway R2 adjacent to the first roadway R1 on which the vehicle M is traveling from among one or more other vehicles m, generates one or more virtual lane markings IL partitioning the second roadway R2 on the basis of the target vehicle in a case where the vehicle M is scheduled to move from the first roadway R1 to the second roadway R2 on the basis of a behavior of the target vehicle and a road lane marking partitioning the second roadway R2 in the vicinity of the target vehicle cannot be recognized, controls the vehicle M on the basis of the generated one or more virtual lane markings IL and the target vehicle, and can thus cause the vehicle to more smoothly travel in a desired direction.

Hardware Configuration

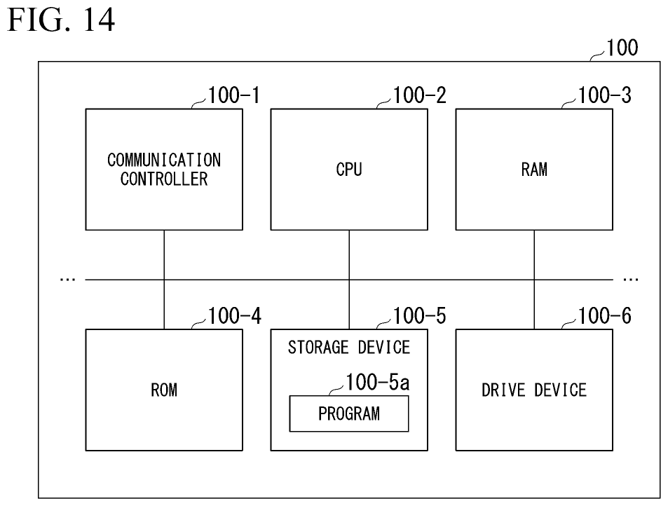

FIG. 14 is a diagram showing an example of a hardware configuration of the automated driving control device 100 of the embodiment. As shown in FIG. 14, the automated driving control device 100 is configured to include a communication controller 100-1, a CPU 100-2, a random access memory (RAM) 100-3 used as a working memory, a read only memory (ROM) 100-4 storing a boot program or the like, a storage device 100-5 such as a flash memory or an hard disk drive (HDD), and a drive device 100-6 that are connected to each other via an internal bus or a dedicated communication line. The communication controller 100-1 performs communication with constituents other than the automated driving control device 100. The storage device 100-5 stores a program 100-5a executed by the CPU 100-2. The program is loaded to the RAM 100-3 by a direct memory access (DMA) controller (not shown), and is executed by the CPU 100-2. Consequently, either or both of the recognizer 130 and the action plan generator 140 are realized.

The embodiments may be expressed as follows.

A vehicle control device includes a storage device storing a program, and a hardware processor, in which the hardware processor executes the program stored in the storage device, and thus

acquires a recognition result that is recognized by a recognizer recognizing a periphery of a vehicle,

controls an action of the vehicle,

determines a target vehicle traveling on a second roadway adjacent to a first roadway on which the vehicle is traveling from among one or more other vehicles included in the acquired recognition result,

generates one or more virtual lane markings partitioning the second roadway on the basis of the target vehicle in a case where the vehicle is scheduled to move from the first roadway to the second roadway on the basis of a behavior of the target vehicle and a road lane marking partitioning the second roadway in the vicinity of the target vehicle cannot be recognized, and

controls the vehicle on the basis of the generated one or more virtual lane markings and the target vehicle.

As mentioned above, the mode for carrying out the present invention has been described by using the embodiment, but the present invention is not limited to the embodiment, and various modifications and replacements may occur within the scope without departing from the spirit of the present invention.

What is claimed is:

1. A vehicle control device comprising:
an acquirer that is configured to acquire a recognition result that is recognized by a recognizer recognizing a periphery of a vehicle; and
an action controller that is configured to control an action of the vehicle,
wherein the action controller is configured to
determine a target vehicle traveling on a second roadway adjacent to a first roadway on which the vehicle is traveling from among one or more other vehicles included in the recognition result acquired by the acquirer,
generate one or more virtual lane markings partitioning the second roadway on the basis of the target vehicle in a case where the vehicle is scheduled to move from the first roadway to the second roadway on the basis of a behavior of the target vehicle and a road lane marking partitioning the second roadway in a vicinity of the target vehicle cannot be recognized, and
control the vehicle on the basis of the generated one or more virtual lane markings and the target vehicle.

2. The vehicle control device according to claim 1,
wherein the action controller is configured to generate the one or more virtual lane markings extending in a traveling direction of the target vehicle.

3. The vehicle control device according to claim 1,
wherein the action controller is configured to generate a first virtual lane marking that partitions the second roadway extending in a traveling direction of the target vehicle, and a second virtual lane marking that is present at a position farther than the first virtual lane marking from the vehicle and extends in parallel to the first virtual lane marking.

4. The vehicle control device according to claim 3,
wherein the action controller is configured to generate the second virtual lane marking in a case where the target vehicle moves to a third roadway adjacent to the second roadway.

5. The vehicle control device according to claim 3,
wherein the action controller is configured to
generate the first virtual lane marking on a right of the second roadway with respect to an advancing direction of the vehicle in a case where a right roadway with respect to the advancing direction of the vehicle is set to the second roadway, and
generate the first virtual lane marking on a left of the second roadway with respect to the advancing direction of the vehicle in a case where a left roadway with respect to the advancing direction of the vehicle is set to the second roadway.

6. The vehicle control device according to claim 1,
wherein the action controller is configured to generate a third virtual lane marking that is located along a trajectory along which the vehicle is scheduled to move and is connected to a lane partitioned by a first virtual lane marking or a lane partitioned by a second virtual lane marking in a case where a road lane marking partitioning the second roadway in the vicinity of the target vehicle is not recognizable,
wherein the first virtual lane marking is a lane marking partitioning the second roadway extending in a traveling direction of the target vehicle, and
wherein the second virtual lane marking is a lane marking that is generated at a position farther than the first virtual lane marking from the vehicle and extends in parallel to the first virtual lane marking.

7. The vehicle control device according to claim 6,
wherein the action controller is configured to determine whether the third virtual lane marking will be connected to the lane partitioned by the first virtual lane marking or the lane partitioned by the second virtual lane marking on the basis of a trajectory along which the vehicle is scheduled to move.

8. A vehicle control method of causing a computer to:
acquire a recognition result that is recognized by a recognizer recognizing a periphery of a vehicle;
control an action of the vehicle;
determine a target vehicle traveling on a second roadway adjacent to a first roadway on which the vehicle is traveling from among one or more other vehicles included in the acquired recognition result;
generate one or more virtual lane markings partitioning the second roadway on the basis of the target vehicle in a case where the vehicle is scheduled to move from the first roadway to the second roadway on the basis of a behavior of the target vehicle and a road lane marking partitioning the second roadway in a vicinity of the target vehicle cannot be recognized; and
control the vehicle on the basis of the generated one or more virtual lane markings and the target vehicle.

9. A non-transitory computer readable storage medium storing a program causing a computer to:
acquire a recognition result that is recognized by a recognizer recognizing a periphery of a vehicle;
control an action of the vehicle;
determine a target vehicle traveling on a second roadway adjacent to a first roadway on which the vehicle is traveling from among one or more other vehicles included in the acquired recognition result;
generate one or more virtual lane markings partitioning the second roadway on the basis of the target vehicle in a case where the vehicle is scheduled to move from the first roadway to the second roadway on the basis of a behavior of the target vehicle and a road lane marking partitioning the second roadway in a vicinity of the target vehicle cannot be recognized; and
control the vehicle on the basis of the generated one or more virtual lane markings and the target vehicle.
